(19) United States
(12) Patent Application Publication
(10) Pub. No.: US 2022/0179136 A1
(43) Pub. Date: Jun. 9, 2022

(54) OPTICAL ELEMENT ARRAY STRUCTURE FOR BIRD COLLISION PREVENTION AND MANUFACTURING METHOD THEREOF

(71) Applicants: UIF (University Industry Foundation), Yonsei University, Seoul (KR); NATIONAL INSTITUTE OF ECOLOGY, Maseo-myeon (KR)

(72) Inventors: Jong Souk YEO, Incheon (KR); Seung Muk JI, Incheon (KR); Deok Jin JEON, Incheon (KR); Jin Hee KIM, Suwon (KR)

(21) Appl. No.: 17/510,089

(22) Filed: Oct. 25, 2021

(30) Foreign Application Priority Data
Dec. 9, 2020 (KR) 10-2020-0171586

(51) Int. Cl. G02B 5/18; G02B 1/00; A01M 29/08

(52) U.S. Cl. CPC G02B 5/1852; A01M 29/08; G02B 1/005; G02B 5/1838

(57) ABSTRACT

The present exemplary embodiments provide an optical array which reduces the collision of the birds by means of a recognizable optical structure in a situation in which flying birds quickly approaches in various directions and ensures 80% or higher of transparency of a device surface and a manufacturing method thereof.

### CROSS-REFERENCE TO RELATED APPLICATIONS

This application claims priority to and the benefit of Korean Patent Application No. 10-2020-0171586 filed in the Korean Intellectual Property Office on Dec. 9, 2020, the entire contents of which are incorporated herein by reference.

### TECHNICAL FIELD

A technical field of the present disclosure relates to an optical element array which is selected and disposed to prevent collision of wild birds against building glass and sound barriers and a manufacturing method thereof.

The present invention relates to a process technology development research to implement a biomimicry structural color carried out by the National Institute of Ecology in 2021 with the funding of the Ministry of Environment (No. 2011-11-0613), and development of a high contrast structural color and metachromatic surface implementation technology which imitates a low reflection and photonic crystal structure of the nature, supported by the National Research Foundation, and supervised by Yonsei University in 2021 with the funding of the Ministry of Education (No. 2021-11-0524).

### BACKGROUND ART

The contents described in this section merely provide background information on the present exemplary embodiment but do not constitute the related art.

A bird collision prevention film of the related art uses a pattern of reflecting light and a color contrast thereof is reduced according to a surrounding environment so that it is difficult for the birds to clearly recognize the color contrast. Further, colored stickers have a limit to being easily damaged due to exposure to the external environment.

### RELATED ART DOCUMENT

### Patent Document

(Patent Document 1) Korean Unexamined Patent Application Publication No. 10-2017-0012289 (published on Feb. 2, 2017)

(Patent Document 2) Korean Unexamined Patent Application Publication No. 10-2020-0055714 (published on May 21, 2020)

### SUMMARY

A major object of exemplary embodiments of the present disclosure is to minimize overall reflection and transmission characteristic changes of an application target using an optical element which structurally diffracts and scatters ultraviolet rays and visible rays and provide aesthetic improvement by being clearly recognized by the birds without obstructing a field of vision of human.

Another object is to increase recognizability of the flying birds for the pattern by means of various arrangements of optical elements and enable various manufacturing methods to be selected according to characteristics of the optical elements.

Other and further objects of the present invention which are not specifically described can be further considered within the scope easily deduced from the following detailed description and the effect.

According to an aspect of the present embodiment, an optical array apparatus for preventing collision of birds includes a base; and an optical array which is formed on the base to diffract or scatter light, and the optical array includes a bird recognizable optical element which diffracts or scatters ultraviolet rays and/or visible rays.

An average interval between the bird recognizable optical elements 210 may be set to be 5 cm or shorter in length.

The bird recognizable optical elements are periodically or aperiodically disposed, the bird recognizable optical elements are anisotropically or isotropically disposed with respect to a reference direction, the bird recognizable optical elements are formed by the same type or different types, and Lattices of the bird recognizable optical elements may be formed with the same alignment or different alignments.

The minimum size of the bird recognizable optical element is set to be 3 mm or has a size which shows an optical reflecting or scattering effect equivalent thereto.

The bird recognizable optical element has an overall coverage ratio of a pattern which is smaller than 0.1 and a transparency of a glass surface for visible ray according to a pattern which is 80% or higher.

The bird recognizable optical element has a linear, radial, or two-dimensional grating structure which diffracts a specific wavelength band, a structure having a wavelength band which is transparent for a visible ray and scatters the ultraviolet rays, a two-dimensional or three-dimensional photonic crystal structure which reflects light having a specific wavelength, or a structure which causes diffusive reflection for a broad band wavelength.

The bird recognizable optical element is formed by attaching a diffractive grating on the base and the diffractive grating has a one-dimensional, two-dimensional, or three-dimensional photonic crystal structure or a nano-particle self-assembly to reflect or scatter a specific wavelength.

The bird recognizable optical element has a particle size in the range of 250 to 500 nm and five or less particle layers of the bird recognizable optical element are stacked.

The optical array includes a human recognizable optical element which diffracts or scatters visible rays.

The human recognizable optical element is disposed in a part of a region in which the bird recognizable optical element is disposed and the human recognizable optical element represents a pattern shape, a reference line, a reflection angle, a reflection direction, and a reflection intensity of the bird recognizable optical element or a combination thereof.

The human recognizable optical element represents a length and a numerical value of the length.

According to another aspect of the present embodiment, a manufacturing method of an optical array for preventing collision of birds includes preparing a base; and forming an optical array which diffracts or scatters light on the base, the optical array includes a bird recognizable optical element which diffracts or scatters ultraviolet rays and/or visible rays.

In the forming of an optical array, the optical array is patterned or attached onto the base, is directly engraved by an imprinting method of hot embossing, which includes a pre-mold manufacturing process, is directly patterned by CO₂ laser melting or ultraviolet layer ablation method, is assembled on a heterogeneous substrate to move the base, moves the optical array formed on the heterogeneous substrate to the base by a transfer printing method by selective laser absorption, or is manufactured on an adhesive substrate so as to be attached onto the base.

As described above, according to the exemplary embodiments of the present disclosure, when birds rapidly approach in various directions, an recognizable optical structure is used to reduce the collision of the birds and ensure 80% or higher of transparency of a surface of the device.

Further, even though an optical element has an unnoticeable size, if the optical elements are periodically and isotropically disposed, the optical effect by the periodicity may appear from a distance so that it is effective to prevent the collision.

Even if the effects are not explicitly mentioned here, the effects described in the following specification which are expected by the technical features of the present disclosure and their potential effects are handled as described in the specification of the present disclosure.

### BRIEF DESCRIPTION OF THE DRAWINGS

FIGS. 1 and 2 are views illustrating a method for manufacturing an optical array for preventing collision of birds according to an exemplary embodiment of the present disclosure;

FIG. 3 is a view illustrating an optical array apparatus for preventing collision of birds according to another exemplary embodiment of the present disclosure;

FIG. 4 is a view illustrating an optical array pattern of an optical array apparatus for preventing collision of birds according to another exemplary embodiment of the present disclosure;

FIGS. 5 and 6 are views illustrating an optical array of an optical array apparatus for preventing collision of birds according to another exemplary embodiment of the present disclosure;

FIG. 7 is a view illustrating an optical element of an optical array apparatus for preventing collision of birds according to another exemplary embodiment of the present disclosure;

FIG. 8 is a view illustrating a diffractive grating of an optical element of an optical array apparatus for preventing collision of birds according to another exemplary embodiment of the present disclosure; and

FIG. 9 is a view illustrating an example of an optical element having a selective wavelength transmittable structure in an optical array apparatus for preventing collision of birds according to another exemplary embodiment of the present disclosure and an optical characteristic measurement result.

### DETAILED DESCRIPTION OF THE EMBODIMENT

Hereinafter, in the description of the present disclosure, a detailed description of the related known functions will be omitted if it is determined that the gist of the present disclosure may be unnecessarily blurred as it is obvious to those skilled in the art and some exemplary embodiments of the present disclosure will be described in detail with reference to exemplary drawings.

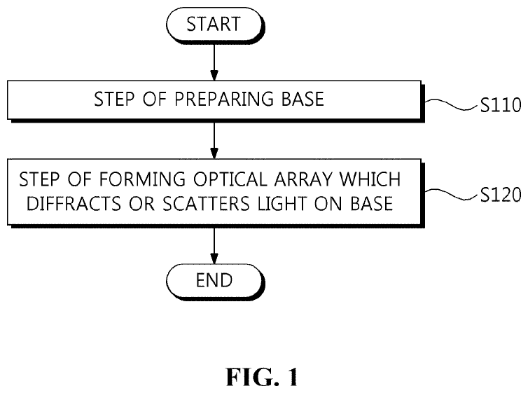

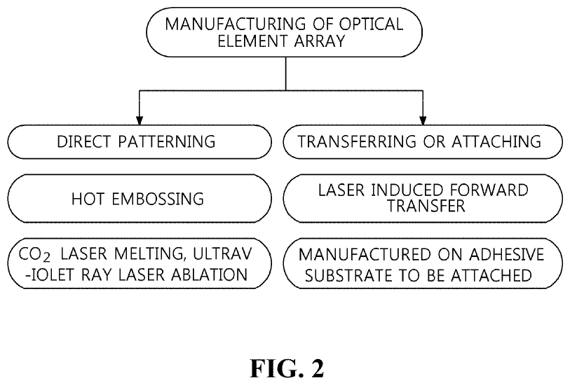

FIGS. 1 and 2 are views illustrating a method for manufacturing an optical array for preventing collision of birds according to an exemplary embodiment of the present disclosure.

Referring to FIG. 1, the method for manufacturing an optical array for preventing collision of birds includes a step S110 of preparing a base and a step S120 of forming an optical array which diffracts or scatters light on the base.

The step S120 of forming an optical array includes a step of forming a bird recognizable optical element and a step of forming a human recognizable optical element. Unlike the human, the birds see ultraviolet rays so that the bird recognizable optical element and the human recognizable optical element may be distinguished with respect to the ultraviolet ray. The bird recognizable optical element diffracts or scatters ultraviolet rays and/or visible rays and the human recognizable optical element diffracts or scatters the visible rays.

Referring to FIG. 2, during the step of forming an optical array, the optical array is patterned or attached onto the base. The base may be glass or a substrate or a film.

During the step of forming an optical array, the optical array may be directly engraved by an imprinting method of hot embossing, which includes a pre-mold manufacturing process.

During the step of forming an optical array, the optical array may be directly patterned by CO₂ laser melting or ultraviolet layer ablation method.

During the step of forming an optical array, the optical array may be assembled on a heterogeneous substrate to move the base.

During the step of forming an optical array, the optical array formed on the heterogeneous substrate may be moved to the base by a printing method such as selective laser absorption transfer (laser induced forward transfer).

During the step of forming an optical array, the optical array may be manufactured on an adhesive substrate so as to be attached onto the base.

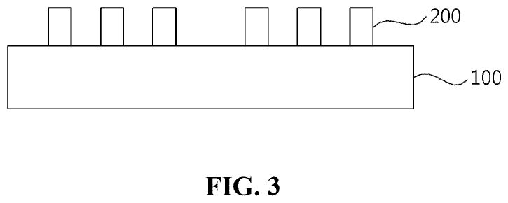

FIG. 3 is a view illustrating an optical array apparatus for preventing collision of birds according to another exemplary embodiment of the present disclosure.

The optical array apparatus for preventing collision of birds includes a base 100 and an optical array 200 which is formed on the base 100 to diffract or scatter light.

The optical array 200 includes a bird recognizable optical element which diffracts or scatters ultraviolet rays and/or visible rays. The optical array 200 includes a human recognizable optical element 220 which diffracts or scatters visible rays.

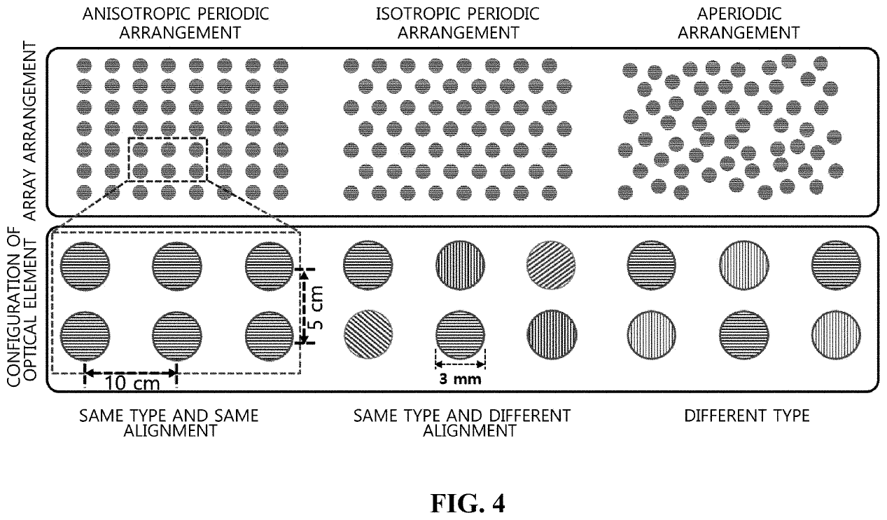

FIG. 4 is a view illustrating an optical array pattern of an optical array apparatus for preventing collision of birds according to another exemplary embodiment of the present disclosure.

The bird recognizable optical elements may be periodically or aperiodically disposed.

The bird recognizable optical elements may be anisotropically or isotropically disposed with respect to a reference direction.

The bird recognizable optical elements may be formed by the same type or different types.

Gratings of the bird recognizable optical elements may be formed with the same alignment or different alignments.

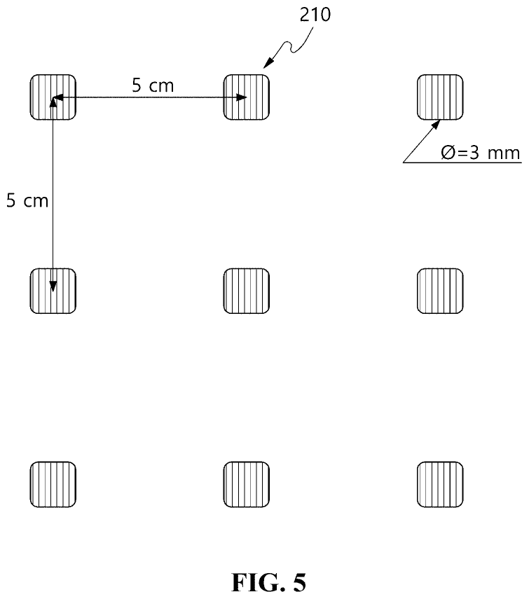

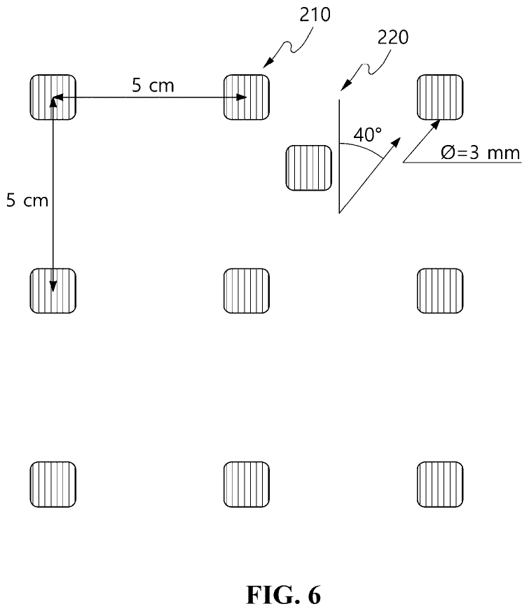

FIGS. 5 and 6 are views illustrating an optical array of an optical array apparatus for preventing collision of birds according to another exemplary embodiment of the present disclosure.

The optical array includes a bird recognizable optical element which diffracts or scatters ultraviolet rays and visible rays and a human recognizable optical element 220 which diffracts or scatters visible rays.

An average interval between the bird recognizable optical elements 210 may be set to be 5 cm or shorter in length. The flying birds may recognize the bird recognizable optical elements 210 which are disposed with an interval of 5 cm or shorter in length.

A minimum size of the bird recognizable optical element 210 may be set to 3 mm. The birds which fly and approach in various directions reduce a flying speed or turn to ensure a safety distance after recognizing the bird recognizable optical element 210 with a size of 3 mm or larger. A size of 3 mm or larger needs to be ensured in consideration of a relationship between a size of visually perceptive object of the birds and a collision margin distance.

The bird recognizable optical element 210 has an overall coverage ratio of a pattern which is smaller than 0.1 and a transparency of a glass surface for visible ray according to a pattern which is 80% or higher.

When a maximum required average spacing (5 cm) and a minimum size (3 mm) of the optical element is applied to an orthogonal arrangement, the overall coverage rate of the pattern is only 3²/50². When the transparency is reduced proportional to the coverage rate, the transparency of the pattern corresponds to 91%. When it is considered that a transparency of a normal glass is 92% in a visible ray region due to Fresnel reflection at air/glass interface, the transparency of the bird collision prevention surface according to the formation of a pattern is approximately 84%, so that it is predicted that it is significantly transparent. Further, the optical element proposed by the present disclosure is also significantly transparent so that the actual transparency may be further improved.

The human recognizable optical element 220 is an optical element required for an operator who installs the optical array apparatus for preventing the collision of the birds to distinguish. A flying path scenario of the birds may be restricted according to an installation environment such as a direction of light day and night, an intensity of light, and structure placement. A pattern designed to be suitable for the installation environment may be required and means for distinguishing the bird recognizable optical element 210 in accordance with the requirements is necessary.

The human recognizable optical element 220 is disposed in a part of a region in which the bird recognizable optical element 210 is disposed and the human recognizable optical element 220 may represent a pattern shape, a reference line, a reflection angle, a reflection direction, and a reflection intensity of the bird recognizable optical element or a combination thereof. The human recognizable optical element 220 may represent a length and a numerical value of the length.

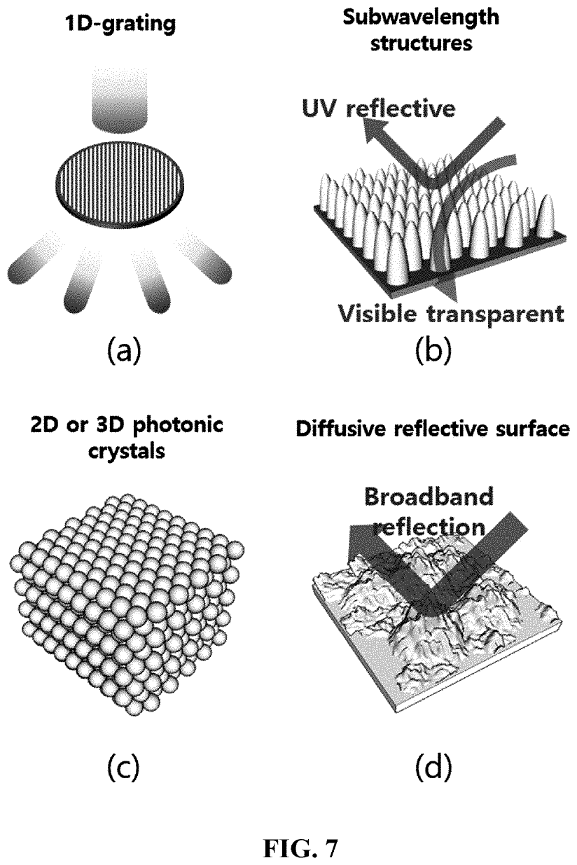

FIG. 7 is a view illustrating an optical element of an optical array apparatus for preventing collision of birds according to another exemplary embodiment of the present disclosure.

The bird recognizable optical element 210 may be formed with a linear, radial, or two-dimensional grating structure which diffracts a specific wavelength band.

The bird recognizable optical element 210 may be formed with a structure having a wavelength band which is transparent for a visible ray and scatters the ultraviolet rays and have a structure which is recognizable only by the birds.

The bird recognizable optical element 210 may be formed with a one-dimensional, two-dimensional, or three-dimensional photonic crystal structure which reflects light having a specific wavelength. The bird recognizable optical element 210 is a nano-particle assembly which reflects or scatters a specific wavelength.

The bird recognizable optical element 210 may be formed with a structure which causes diffusive reflection for a broad band wavelength. The bird recognizable optical element 210 controls a wavelength of discontinuous section in consideration of a natural environment to be installed.

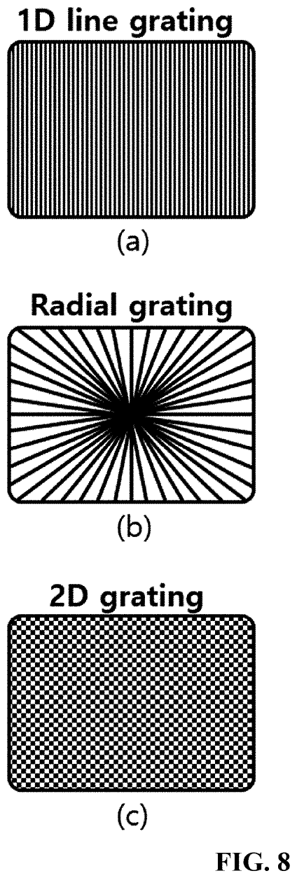

FIG. 8 is a view illustrating a diffractive grating of an optical element of an optical array apparatus for preventing collision of birds according to another exemplary embodiment of the present disclosure.

The bird recognizable optical element may be formed by attaching a diffractive grating onto a base. A diffractive grating structure is transferred onto a polymer substrate and then attached onto a glass plate. The grating structure may be printed on a glass plate or a sound barrier using laser.

One-dimensional, two-dimensional, or three-dimensional photonic crystal structure or a nano-particle self-assembly is used as the diffractive grating structure to reflect or scatter a specific wavelength. A very tiny metal nano-particle may scatter a specific wavelength using a plasmon resonance phenomenon.

By doing this, the recognizability of the flying birds of the building glass and the transparent sound barrier may be increased.

The bird recognizable optical element has a particle size in the range of 250 to 500 nm. By doing this, the significant scattering or reflection in the UV and visible ray region is caused while maintaining some degree of transparency. Here, a nano-particle layer in the range of 250 to 500 nm may be formed to have a size which causes significant reflection or scattering against the ultraviolet ray which is recognizable by the birds and ensures a high transmittance for visible ray which is visible to the human.

Five or less particle layers of the bird recognizable optical element are stacked. The number of particle layers may be limited to maintain some degree of transparency.

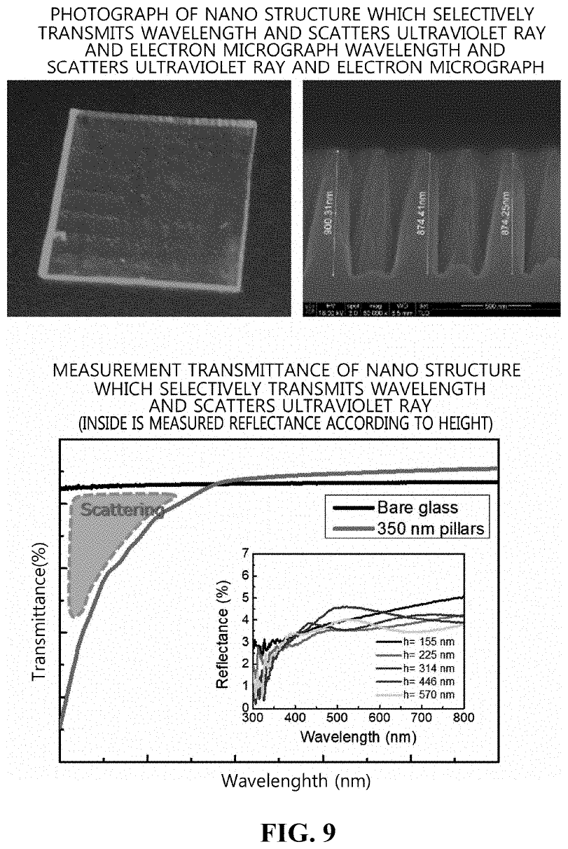

FIG. 9 is a view illustrating an example of an optical element with a structure which selectively transmits a wavelength and scatters ultraviolet rays in an optical array apparatus for preventing collision of birds according to another exemplary embodiment of the present disclosure and an optical characteristic measurement result of the optical element.

A conical shape, a polygonal pyramid shape, a cone shape, and a columnar shape are disposed in a predetermined pattern. For example, the shapes are disposed at an equal interval or in a zigzag pattern and a ratio of transmitted light and reflected light may be controlled by adjusting a ratio of a height and a width of a pillar. Although it is described that the respective processes of the manufacturing method are sequentially performed, this is merely illustrative and those skilled in the art may apply various modifications and changes by partially changing the order of the method or performing one or more processes in parallel or adding another process without departing from the essential gist of the exemplary embodiment of the present disclosure.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

What is claimed is:

1. An optical array apparatus for preventing collision of birds, comprising:
a base; and
an optical array which is formed on the base to diffract or scatter light,
wherein the optical array includes a bird recognizable optical element which diffracts or scatters ultraviolet rays and/or visible rays.

2. The optical array apparatus according to claim 1, wherein an average interval between the bird recognizable optical elements is set to be 5 cm or shorter in length.

3. The optical array apparatus according to claim 1, wherein the bird recognizable optical elements are periodically or aperiodically disposed, the bird recognizable optical elements are anisotropically or isotropically disposed with respect to a reference direction, the bird recognizable optical elements are formed by the same type or different types, and gratings of the bird recognizable optical elements are formed with the same alignment or different alignments.

4. The optical array apparatus according to claim 1, wherein a minimum size of the bird recognizable optical element is set to be 3 mm.

5. The optical array apparatus according to claim 1, wherein the base is implemented by a transparent material and the bird recognizable optical element has an overall coverage ratio of a pattern which is smaller than 0.1 and a transparency of a glass surface for visible ray according to a pattern which is 80% or higher.

6. The optical array apparatus according to claim 1, wherein the bird recognizable optical element has a linear, radial, or two-dimensional grating structure which diffracts a specific wavelength band, a structure having a wavelength band which is transparent for a visible ray and scatters the ultraviolet rays, a two-dimensional or three-dimensional photonic crystal structure which reflects light having a specific wavelength, or a structure which causes diffusive reflection for a broad band wavelength.

7. The optical array apparatus according to claim 1, wherein the bird recognizable optical element is formed by attaching or printing a diffractive grating on the base and the diffractive grating has a one-dimensional, two-dimensional, or three-dimensional photonic crystal structure or a nano-particle assembly to reflect or scatter a specific wavelength.

8. The optical array apparatus according to claim 1, wherein the bird recognizable optical element has a particle size in the range of 250 to 500 nm and five or less particle layers of the bird recognizable optical element are stacked.

9. The optical array apparatus according to claim 1, wherein the optical array includes a human recognizable optical element which diffracts or scatters visible rays.

10. The optical array apparatus according to claim 1, wherein the human recognizable optical element is disposed in a part of a region in which the bird recognizable optical element is disposed and the human recognizable optical element represents a pattern shape, a reference line, a reflection angle, a reflection direction, and a reflection intensity of the bird recognizable optical element or a combination thereof.

11. The optical array apparatus according to claim 9, wherein the human recognizable optical element represents a length and a numerical value of the length.

12. A manufacturing method of an optical array for preventing collision of birds, comprising:
preparing a base; and
forming an optical array which diffracts or scatters light on the base,
wherein the optical array includes a bird recognizable optical element which diffracts or scatters ultraviolet rays and/or visible rays.

13. The manufacturing method of an optical array according to claim 12, wherein in the forming of an optical array, the optical array is patterned or attached onto the base, is directly engraved by an imprinting method of hot embossing, which includes a pre-mold manufacturing process, is directly patterned by CO₂ laser melting or ultraviolet layer ablation method, is assembled on a heterogeneous substrate to move the base, moves the optical array formed on the heterogeneous substrate to the base by a transfer printing method by selective laser absorption, or is manufactured on an adhesive substrate so as to be attached onto the base.

14. The manufacturing method of an optical array according to claim 12, wherein the optical array includes a human recognizable optical element which diffracts or scatters visible rays.
